(19) United States
(12) Patent Application Publication
(10) Pub. No.: US 2010/0175573 A1
(43) Pub. Date: Jul. 15, 2010

(54) Explosively formed penetrator detection and passive infrared sensor neutralization system

(75) Inventors: Alan Cornett, Andover, MN (US); Robert C. Becker, Eden Prairie, MN (US); Doug Carlson, Woodbury, MN (US); David W. Meyers, Brooklyn Park, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/214,143

(22) Filed: Jun. 17, 2008

(51) Int. Cl. F42C 13/02; F42C 13/04; G01S 13/00

(52) U.S. Cl. 102/201; 342/54; 342/53

(57) ABSTRACT

An apparatus for remote detection or neutralization of an explosively formed penetrator device. A LIDAR or LADAR unit may be used in conjunction with a RADAR unit to both detect the presence of an EFP and neutralize the EFP having an associated passive infrared sensor. The LIDAR unit's wavelength is selected to approximate the signature from the intended EFP target which then causes the safe remote detonation of the EFP. The detected EFP signature may be compared with known signatures and presented to a user via a display terminal. The display terminal may also present associated terrain or GPS data.

### BACKGROUND

The present invention pertains to neutralization of passive infrared sensors (PIRs). More particularly, the invention pertains to detection and neutralization of explosively formed penetrator (EFP) improvised explosive devices (IEDs) which use a PIR.

### SUMMARY

The invention is a detection and neutralization device for EFP devices. A LIDAR and RADAR unit may be used in conjunction to detect the presence of an EFP, and optionally, to detonate the EFP at a greater standoff distance.

### BRIEF DESCRIPTION OF THE DRAWING

FIG. 1a is a diagram of an explosively formed penetrator (EFP);

FIG. 1b is a diagram showing the time-evolution of the self-forming fragment that occurs after detonation of an EFP;

FIG. 2 is a diagram showing an IED using a remote control to arm a PIR-based trigger for an EFP with an intended target vehicle;

FIG. 3 is a diagram showing a prior art offset radiation source commonly used to pre-detonate PIR triggered LED's using EFPs along with a method used to counteract the effect of an offset triggering device;

FIG. 4 is a block diagram showing elements that may be used to detect and neutralize an EFP in accordance with the preferred embodiment;

FIG. 5a is a sample representation of a LIDAR image; and

FIG. 5b is a representative threat signature of an EFP after the blending and/or fusing algorithm.

### DESCRIPTION

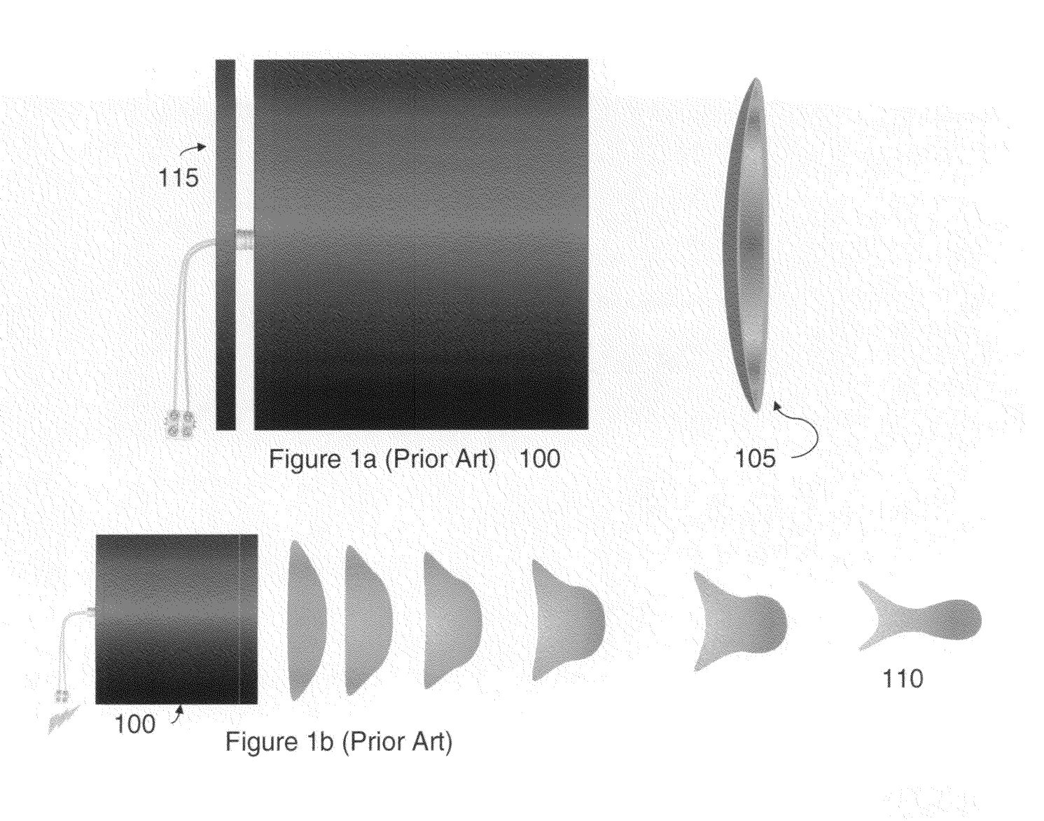

As shown in FIG. 1a, a common form of an EFP used as an IED may be constructed from a one to twelve inch diameter pipe 100, often formed of steel, but which can also exist in larger sizes and may be formed from other materials. One end of the pipe is sealed with a welded steel plate 115. The steel plate 115 may be drilled in the center to prime with a blasting cap. The pipe is then filled with at least one highly explosive material and an inwardly dished steel or copper plate 105 is fitted to the other end of the steel pipe. The dished plate end is considered the front of the weapon. The EFP is often packaged inside foam or other material to disguise its presence.

When the EFP is detonated as shown in FIG. 1b, the dished plate is formed into a projectile when hit by the detonation wave from the explosion of the explosive material. This plate 105 then forms a projectile which takes the shape of a metal dart 110, with a velocity approaching 2000 meters per second, which is often capable of penetrating an armor plate up to ten centimeters thick at a range of over one hundred meters. EFPs are considered to be a simple to construct weapon, with high directional capabilities, used in close proximity to an intended target. Because they can be aimed with great accuracy and can penetrate some types of vehicular armor, it is considered by some to be the most deadly form of IED.

EFPs are often used in close proximity to their targets, with most engagements occurring in less than 25 meters. EFPs have recently been used by insurgents against armored cars passing through locations on a road where vehicles must slow down, such as an intersection or corners. The detonation of the EFP has historically been done with a wired connection or radio control.

Previous methods to neutralize the detonation of EFPs included radio frequency jamming systems mounted to the front of armored vehicles. These systems were used to prevent the triggering radio signal from being received by the EFP and thus rendering the EFP ineffective. This method of neutralization is only effective as long as the jamming system is within an appropriate proximity to the triggering radio receiver.

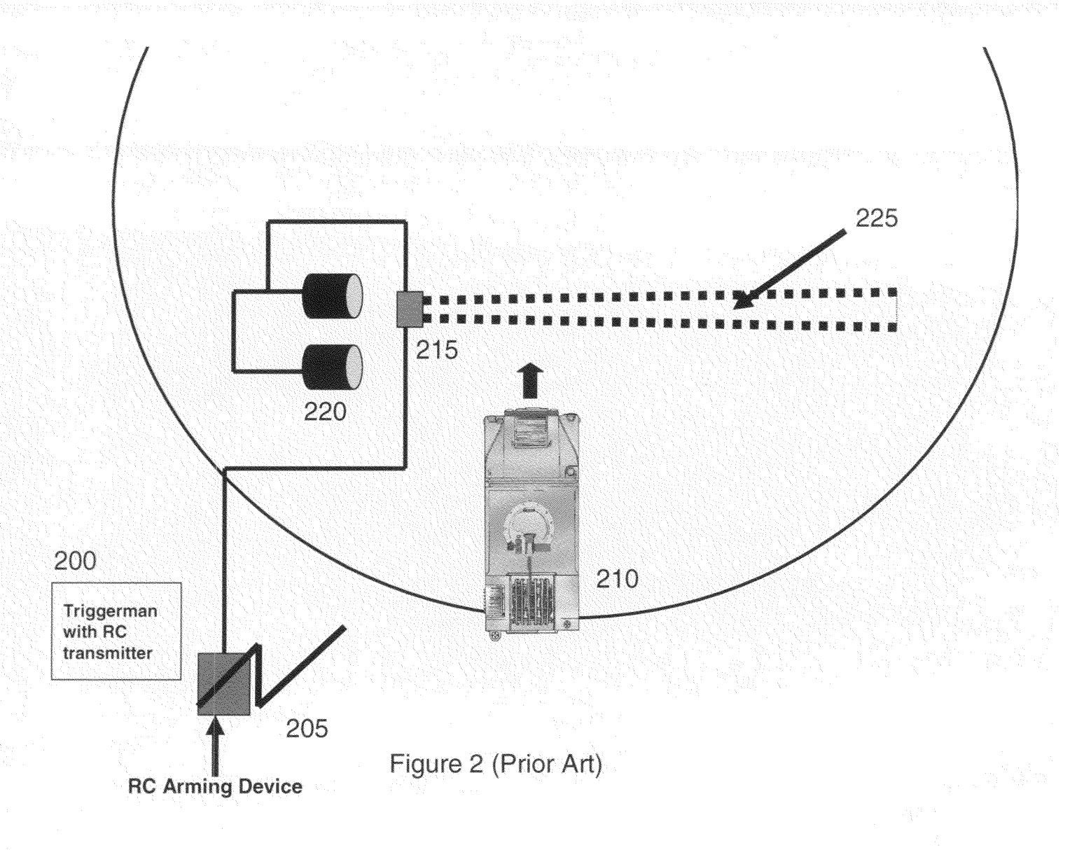

Effective jamming efforts caused the insurgents who deployed the IED to develop a trigger based on a passive infrared (PIR) sensor as shown in FIG. 2. PIR sensors are commonly used in home security applications. A PIR is a device capable of measuring the infrared radiation emitted from objects within its field of view. The insurgent or triggerman 200 for the EFP arms the PIR sensor 215 by remote control. The remote control receiver 205 is typically mounted away from the EFP devices 220 and is usually connected to the PIR by command wire. The PIR sensors 215 are capable of detonating the EFP devices 220 based on a specific thermal signature and motion.

For an EFP using a PIR, the device is detonated, after being remotely armed, by a specific vehicle 210 passing through the PIR sensor's footprint or predetermined detonation area 225 as shown in FIG. 2. This has unfortunately proven to be a highly effective way to attack vehicles, especially since the PIR 215 has no emissions that could be used to reveal its presence. Common PIR sensors have the highest sensitivity to infrared emissions at the 10.6 micron wavelength, which are typical of emissions due to heat from humans and engine driven machines (vehicles).

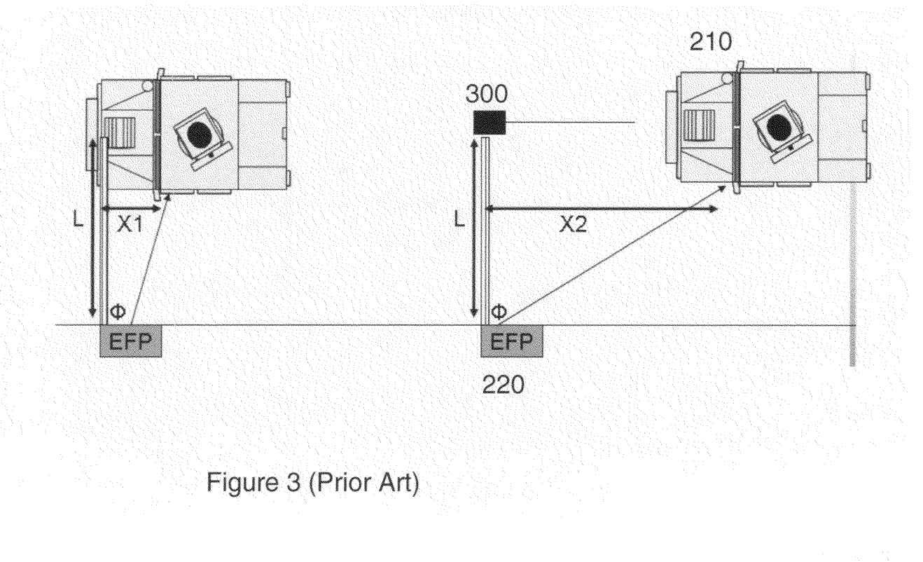

One method to defeat PIR type EFPs has been to include a radiation source 300, as shown in FIG. 3, mounted a predetermined distance in front of the crew vehicle 210 on a long arm, and commonly called a “rhino horn.” Insurgents have learned to counter this defensive measure by staggering the EFP the same distance away from the PIR as the radiation source 300 is from the crew vehicle 210.

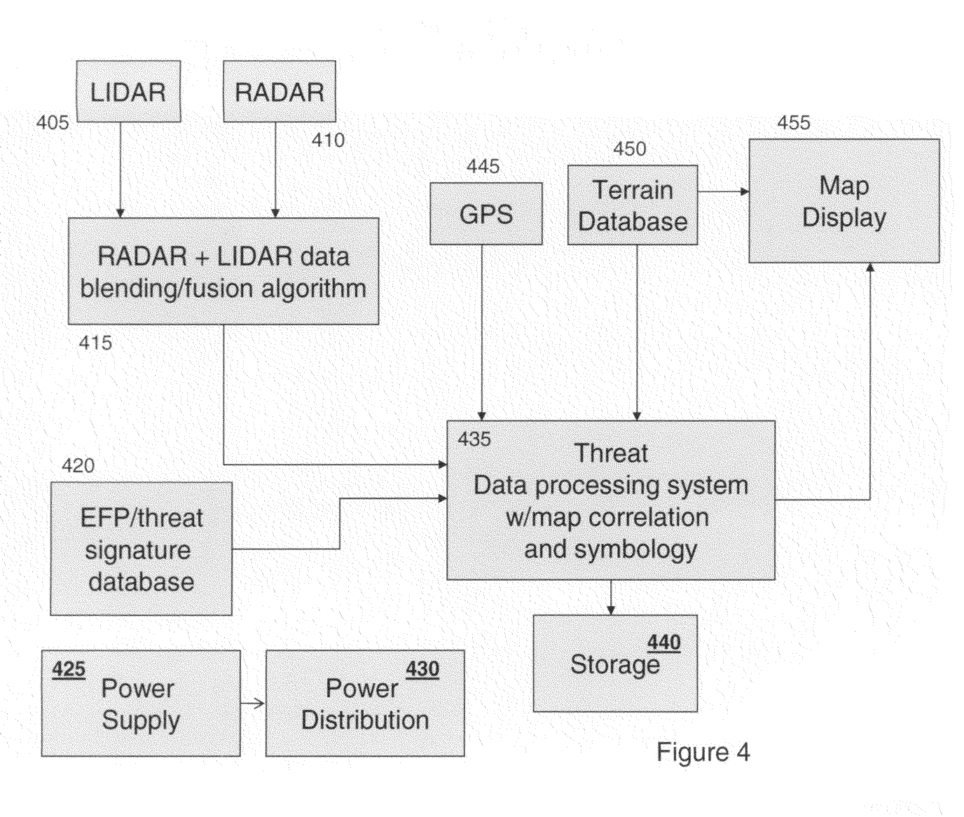

In the present invention, as shown in FIG. 4, detection and/or neutralization of the IED may also be effectively accomplished by the use of light detection and ranging (LIDAR) sensor or a laser detection and ranging (LADAR) sensor. LIDAR sensing technology measures scattered light, usually from a laser beam, to find range and/or other information about a target. In the present invention, a LIDAR sensor can be used having a wavelength of 10.6 microns. The selection of the wavelength at or around 10.6 microns gives the LIDAR the dual purpose of imaging the scene around the crew vehicle 210, as well as providing the scene with an appropriate infrared radiation source that will trigger the PIR sensor and detonate the IED a safe distance away.

Because the LIDAR sensor may have difficulty detecting EFPs in extremely dusty or foggy environments or those hidden behind foam covers, an additional millimeter wave (MMW) RADAR may also be incorporated to provide an image of the surrounding area and the EFP. MMW RADAR does not provide the resolution of a LIDAR system, but has the ability to penetrate any negative atmospheric conditions and most of the material commonly used to disguise an EFP.

LIDAR scanners offer no discernable or tangible evidence of its presence or how it works, and is thus much more likely to prove resistant to the development of an effective countermeasure by the insurgents. Since the LIDAR scans the area ahead of the vehicle, there can be great variability in the range at which the LIDAR will activate a PIR trigger and is thereby immune to simply offsetting the aim of the EFP to compensate for early detonation. It also has the added advantage of not needing to be mounted on a lengthy probe, the rhino horn, as the previous radiation sources required.

The basic detection and neutralization system 660, as shown in FIG. 6, is comprised of a LIDAR unit 405 incorporating a 10.6 micron laser source, a laser steering device, and a MMW RADAR transmitter and receiver 410. The MMW RADAR transmitter preferably operates at a frequency of 94 GHz. A 10.6 micron laser source such as a CO₂ laser, or a source with a wavelength within the peak spectral response of a PIR is preferred for the LIDAR unit 405, due to the close similarity in wavelength to the naturally emitted infrared wavelength of targets such as an armored crew vehicle. The laser selection may also take into account any necessary eye-safe power levels which may be required. The laser source is then steered to provide the ability to scan a scene, thus functioning as a LIDAR system 405. The LIDAR 405 and RADAR 410 can be mounted anywhere on or near the target crew vehicle, provided the line of sight for the LIDAR unit 405 is sufficient to (1) project the LIDAR signal well ahead of the vehicle; (2) remotely trigger the PIR; and (3) scan the side of the road in order to detect an EFP embedded in surrounding terrain. Likewise, the LIDAR 405 and RADAR 410 may be mounted on a non-targeted or non-suspicious surveillance vehicle, such as a taxi which may travel in front of a crew vehicle. Common locations for mounting may include the roof of the target vehicle or even behind the front grill when covert operation is necessary. The LIDAR 405 and RADAR 410 may each individually be connected by means of an IEEE 1394 Firewire cable or USB cable.

If mounted in close proximity, the MMW RADAR 410 can be scanned within the same field of view of the LIDAR system 405 using the same scanning or steering mechanism, thereby eliminating any parallax that could occur if they were scanned separately. The LIDAR scanning or steering mechanism may be any commercially available x-y deflection assembly, such as those sold by Velodyne.

The LIDAR and MMW RADAR images may then be fused in a computer or processor using a blending and/or fusion algorithm 415 so as to present them to an operator as if they were generated by a single sensor. The processor may be contained within a single computer, housing the blending and/or fusion algorithm 415, the threat data processing system 435, and the terrain database 450. Alternatively, the blending and/or fusion algorithm 415 may be contained in a stand-alone processor connected to a computer containing the threat data processing system 435 via an IEEE 1394 Firewire, USB cable, or the like. Such a processor may provide feedback to the LIDAR 405 or RADAR 410 to provide operational control. One example of such operational control would be to modulate the intensity of the LIDAR. In the event of an IED detection, the LIDAR intensity could be increased temporarily so as to increase the range at which a PIR triggered IED would be detonated by the LIDAR.

The blended and/or fused image obtained can be presented as real-time video of the terrain surrounding the target vehicle on an imaging display 455, such as a computer screen or external display, so that the driver of a target vehicle can see any obstacles or IEDs while the LIDAR emits or “paints” the surrounding area with a signal to provide early and safe detonation of any PIR triggered IEDs. Optionally, the output from the blending and/or fusion algorithm 415 may also be transmitted via an IEEE 1394 Firewire or USB cable to another computer or processor containing the threat data processing system 435.

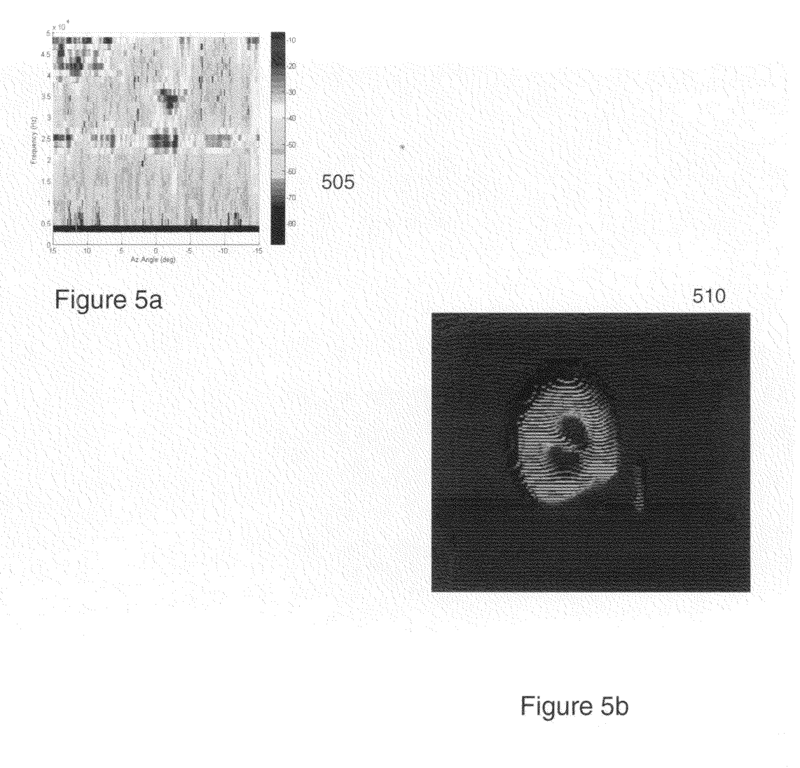

Additionally, the blended or fused LIDAR and RADAR images may be first processed so a determination can be made if an identified device is in fact an EFP. The information may be presented as a specific target signature 505, as shown in FIG. 5a, to a threat data processing system 435, also located on a computer or processor, which may be the same or a different computer or processor used to blend and/or fuse the RADAR and LIDAR data. The threat data processing system 435 compares the blended and/or fused target signature 510, shown in FIG. 5b, and range data with known threat signatures stored in a database or look-up table 420. Non-EFP signatures may then be discarded, while true EFP signatures may be presented to the operator.

The processing system may also accept mapping information from mapping system 660. The mapping system 660 may include a global positioning system (GPS) 445, a terrain database 450, and/or a visual interface or map display unit 455. Common GPS units such as those from Magellan, Trimble, or Garmin may be used.

If location information is provided by the GPS system 445, the threat data processing system 435 can associate a known location with the detection of a possible EFP. If the EFP is not detonated by the LIDAR unit 405, the location may be recorded in storage 440 for future investigation, detonation, or removal. This allows time to detect the method and person used to arm or trigger the EFP, without detonation of the EFP.

The terrain information from the terrain database 450, such as a DTED database, may also be used to determine more specifically where in the local environment the EFP may be hidden, such as a location in a building or hillside. Map display 455 can then be used to present the detected EFP information to the operator.

Power supply 425, such as a vehicle battery, and the chosen power distribution method 430 could supply the necessary power to operate the LIDAR 405, RADAR 410, associated computer equipment containing the blending and/or fusion algorithm 415 and threat data processing system 435, the GPS 445, and the map display 455. If a computer is used, the power supply may also include a laptop battery or the like.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

1. An apparatus for detection or detonation of an explosive device having a passive infrared sensor comprising:
a detection and ranging sensor having an emission wavelength that approximates emissions from the target; and
a millimeter wave RADAR.

2. The apparatus of claim 1, wherein the detection and ranging sensor uses a laser.

3. The apparatus of claim 1, wherein the detection and ranging sensor has a wavelength of approximately 10.6 microns.

4. The apparatus of claim 2, further comprising a scanning mechanism which simultaneously directs the emission from the detection and ranging sensor and the RADAR to the passive infrared sensor.

5. An explosive detection or neutralization device comprising:
a first detection and ranging sensor providing an output signature;
a second detection and ranging sensor providing an second output signature;
a processor for analyzing the first and second output signatures to provide identification of a sensed explosive; and
a display connected to the processor for alerting a user to the identified explosive.

6. The explosive detection or neutralization device of claim 5 wherein said processor provides an image signature of a sensed explosive.

7. The explosive detection or neutralization device of claim 5 wherein said first detection and ranging sensor is capable of remotely triggering the explosive for safe neutralization.

8. The explosive detection and neutralization device of claim 5 further comprising:
a global positioning system to locate of the sensed explosive.

9. The explosive detection and neutralization device of claim 5 further comprising:
a terrain database connected to the processor.

10. An apparatus for providing false signature information to a passive infrared sensor comprising:
a laser having a emission with a wavelength that approximates an expected emission signature that will trigger the passive infrared sensor; and
a scanning device which is used to direct the laser emission to the passive infrared sensor.

11. The apparatus for providing false signature information of claim 10 further comprising:
a millimeter wave RADAR, said RADAR being directed with the scanning device.

12. The apparatus of claim 11 wherein said laser and millimeter wave RADAR are used to scan a scene of interest.

13. The apparatus of claim 12 further comprising a threat processing system which compares selected items from the scanned scene with predetermined known threat features in a database to identify threats in the scanned scene.

14. The apparatus of claim 13 wherein said predetermined known threat features are comprised of threat characteristic threshold levels.

15. The apparatus of claim 13 further comprising a display for presenting an image of an identified threat in a scanned scene to a user.

16. The apparatus of claim 13 wherein said laser is operable to safely neutralize the identified threats in the scanned scene.

17. The apparatus of claim 2 wherein the scanning mechanism, detection and ranging sensor, and RADAR are mounted on a vehicle.

18. The apparatus of claim 13 further comprising a global positioning system and a storage medium, said storage medium operable to record the location of an identified threat with location information provided by the global positioning system.

19. The apparatus of claim 18 further comprising a terrain database connected to said storage medium for recording terrain details with the location of the identified threat.

20. The explosive detection or neutralization device of claim 5 wherein the processor and display are contained within a personal computer.
